(19) United States
(12) Patent Application Publication
(10) Pub. No.: US 2016/0370981 A1
(43) Pub. Date: Dec. 22, 2016

(54) EDITING DEVICE AND METHOD FOR EDIT AND PREVIEW OF LIGHT CONTROL PATTERN

(71) Applicant: UNIFORM INDUSTRIAL CORP., New Taipei City (TW)

(72) Inventor: PO-YU PENG, New Taipei City (TW)

(21) Appl. No.: 14/744,851

(22) Filed: Jun. 19, 2015

(51) Int. Cl. G06F 3/0484; H05B 37/02; H05B 33/08; G06F 3/041

(52) U.S. Cl. CPC G06F 3/04847; G06F 3/0416; H05B 37/0272; H05B 37/0227; H05B 33/0845

(57) ABSTRACT

The instant disclosure provides an editing device and a method for edit and preview of light control pattern. The editing device includes an editing module and a screen. The editing module includes an editing interface. The editing interface includes an input block and a preview block including a simulated lighting device editor. The screen displays the editing interface. When the input block is activated, the editing module records the time of the activation of the input block in one or more light control patterns for light control. When the simulated lighting device editor is activated, the editing module draws one or more diagrammatic marks displayed on the screen. When the preview block is activated, the diagrammatic mark is capable of selectively brightening in accordance with the light control pattern.

### BACKGROUND

Technical Field

The instant disclosure relates to an editing device, and more particularly, to an editing device and a method for edit and preview of light control pattern.

Related Art

During holidays such as Christmas or New Year, many people like to decorate their houses or yards with light strings. Along with night coming and the light strings turning on, the decorated houses or yards have magnificent atmosphere and make people whoever passes by or lives in feel pleasant. A kind of music boxes commercially available connected to the light strings can be used for light control with music playing. The product can increase the effects in a manner of combining light and music. Such music box has a quantity of music and light control patterns respectively corresponding to the music. The music and light control patterns are pre-installed in the music box. Each of the light control patterns is used to control light strings to turn on or off instantaneously in accordance with the rhythms of respective one of the music. To a certain extent, the music is visualized by the light control. Consequently, effects created by combining light control of light strings with music are more attractive than that created by light strings decoration only. Although the music box is of benefit to increase atmosphere, the light control patterns are usually default and are hard to be edited by users, and the user cannot preview the effect of the light control pattern until the decoration of light strings is completed.

### SUMMARY

Products of prior arts regarding light control are hard to be customized to meet vary scenarios and needs. In addition, light control patterns stored in memories of music boxes of prior arts are hard to be edited and previewed by users. To address the above issue, the instant disclosure provides an editing device and a method for edit and preview of light control pattern.

In an embodiment, the editing device comprises an editing module and a screen. The editing module comprises an editing interface. The editing interface comprises an input block and a preview block comprising a simulated lighting device editor. The screen displays the editing interface. When the input block is activated, the editing module records the time of the activation of the input block in at least a light control pattern for light control. When the simulated lighting device editor is activated, the editing module draws at least a diagrammatic mark displayed on the screen. When the preview block is activated, the diagrammatic mark is capable of selectively brightening in accordance with the light control pattern.

According to an embodiment of the instant disclosure, the preview block further comprises an environment photo editor. When the environment photo editor is activated, the editing module displays an environment photo on the screen, and the diagrammatic mark is overlapped on the environment photo.

According to an embodiment of the instant disclosure, the screen is a touch screen. The simulated lighting device editor is activated when an area of the touch screen related to the environment photo senses a point-touch signal or a gesture-touch signal.

According to an embodiment of the instant disclosure, each of the diagrammatic marks selectively brightens in accordance with corresponding one of the light control patterns.

According to an embodiment of the instant disclosure, the editing device further comprises a wireless communication module receiving the light control pattern. The wireless communication module transmits the light control pattern to at least a light control device or to a cloud server signally connected to the light control device via wireless communication protocol.

The instant disclosure further provides embodiments of the method for edit and preview of light control pattern. In an embodiment, the method comprises generating an editing interface on an editing device. The editing interface comprises an input block, a save block, and a preview block. The input block has, when activated, the time of the activation of the input block recorded in at least a light control pattern for light control. The save block saves, when activated, the light control pattern. The preview block comprises a simulated lighting device editor. The method further comprises drawing at least a diagrammatic mark displayed on a screen of the editing device when the simulated lighting device editor is activated. When the preview block is activated, the diagrammatic mark is capable of selectively brightening in accordance with the light control pattern.

According to an embodiment of the instant disclosure, the drawing the diagrammatic mark further comprises drawing the diagrammatic mark when an area of the touch screen related to the environment photo senses a point-touch signal or a gesture-touch signal.

According to an embodiment of the instant disclosure, the method further comprises relating the diagrammatic mark to a corresponding channel.

The editing device and the method for edit and preview of light control pattern of the instant disclosure are of benefit to customization and edition. Users can easily edit light control patterns on the editing device in an instinctive manner. Moreover, users can preview the effect of the light control pattern regarding light controlling.

The features of the instant disclosure will no doubt become understandable to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of an editing device for edit and preview of light control pattern according to a first embodiment of the instant disclosure;

FIG. 2 illustrates a block diagram of an editing device for edit and preview of light control pattern and a light control system to which the editing device applied according to a second embodiment of the instant disclosure;

FIG. 3 illustrates a system level diagram according to the second embodiment of the instant disclosure;

FIG. 4 illustrates an editing interface with a point-touch operation of the editing device according to the second embodiment of the instant disclosure;

FIG. 5 illustrates the editing interface with a gesture-touch operation of the editing device according to the second embodiment of the instant disclosure;

FIG. 6 illustrates a preview block of the editing interface of the editing device according to the second embodiment of the instant disclosure;

FIG. 7 illustrates a block diagram of an editing device for edit and preview of light control pattern and a light control system to which the editing device applied according to a third embodiment of the instant disclosure;

FIG. 8 illustrates a preview block of an editing interface of the editing device according to the third embodiment of the instant disclosure; and

FIG. 9 illustrates a flow chart of a method for edit and preview of light control pattern according to a fourth embodiment of the instant disclosure.

### DETAILED DESCRIPTION

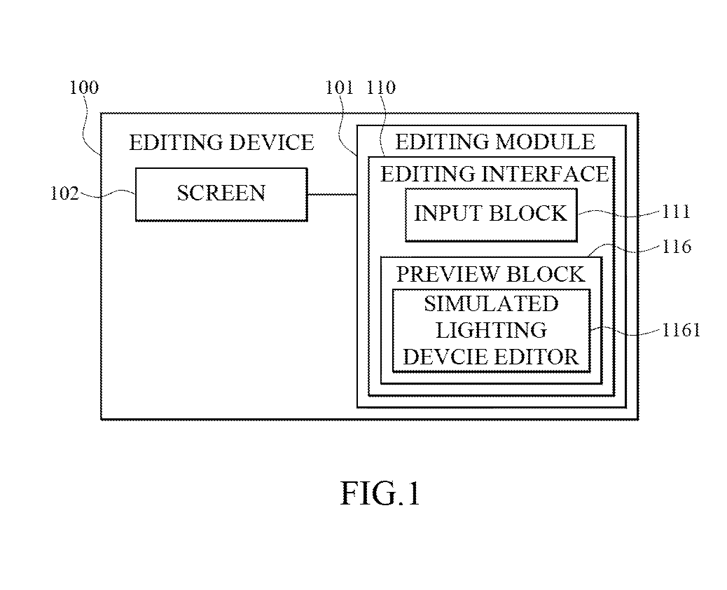

Referring to FIG. 1, FIG. 1 illustrates a block diagram of an editing device 100 for edit and preview of light control pattern according to a first embodiment of the instant disclosure. The editing device 100 is utilized for edit and preview of light control pattern. The light control patterns can be further received and recognized by light control devices such as music boxes. For example, the light control devices can generate light control commands according to the light control patterns to control lighting devices such as light strings having LEDs thereon to have LEDs on the lighting devices turned on or off instantaneously. Users can use the editing device 100 to create, record, and/or edit at least a light control pattern. Moreover, users can preview the effect of simulated light control with regard to the edited light control pattern on the editing device 100. In the embodiment, the editing device 100 is a smart phone. In another embodiment, the editing device is, but is not limited to, a tablet computer or a laptop computer.

The editing device 100 comprises an editing module 101 and a screen 102. The editing module 101 comprises an editing interface 110. The editing interface 110 comprises an input block 111 and a preview block 116. The preview block 116 comprises a simulated lighting device editor 1161. The screen 102 can be utilized for displaying the editing interface 110. In the embodiment, the screen 102 is, but is not limited to, a touch screen. The editing module 101 may include hardware such as a micro controller, an intrinsic memory, and a touch sensor, and software such as firmware and apps (applications installed in the smart phone). When the input block 111 is activated (e.g., a user touches an area of the screen 102 related to the input block 111 such that a touch sensor of the editing module 101 senses/generates a touch signal), the editing module 101 records the time of the activation of the input block 111 in at least a light control pattern for light control. Regarding the edition of the light control pattern, the user can, for example, sing a song by self and knock the input block 111 of the editing interface 110 on the screen 102 along with the rhythms of the song. After editing the light control pattern, user can further activate the preview block 116. The preview block 116 can be utilized for previewing effect of simulated light control in accordance with the edited light control pattern. The simulated lighting device editor 1161 can be activated automatically or manually. When the simulated lighting device editor 1161 is activated, the editing module 101 draws at least a diagrammatic mark displayed on the screen 102. When the preview block 116 is activated, the diagrammatic mark is capable of selectively brightening in accordance with the light control pattern.

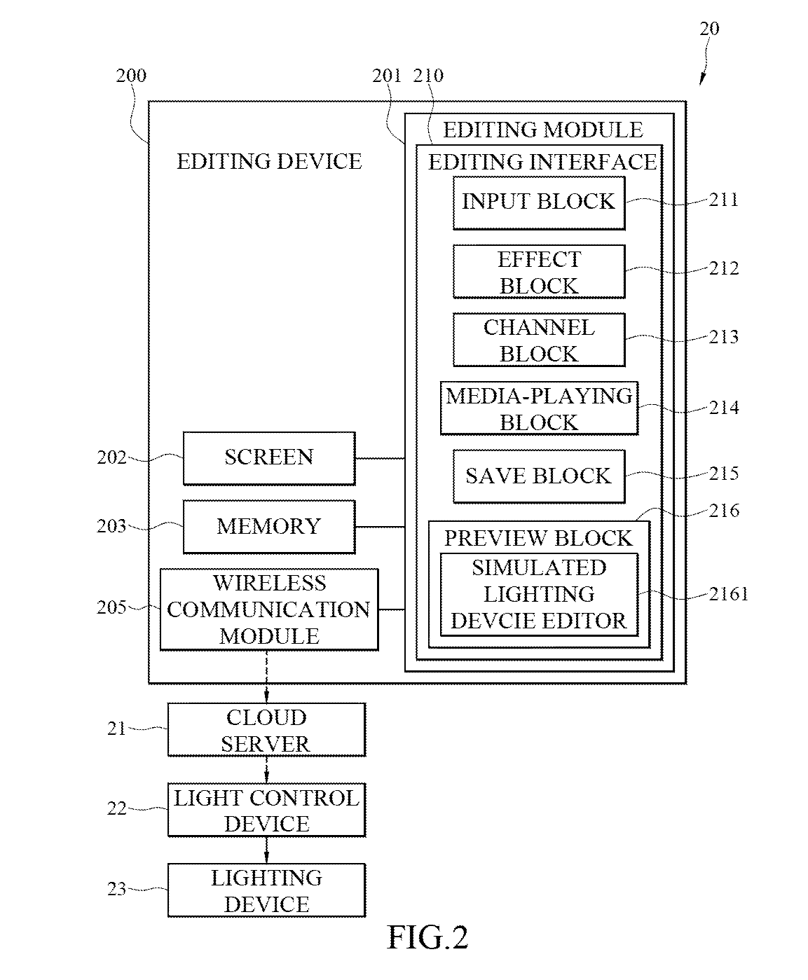

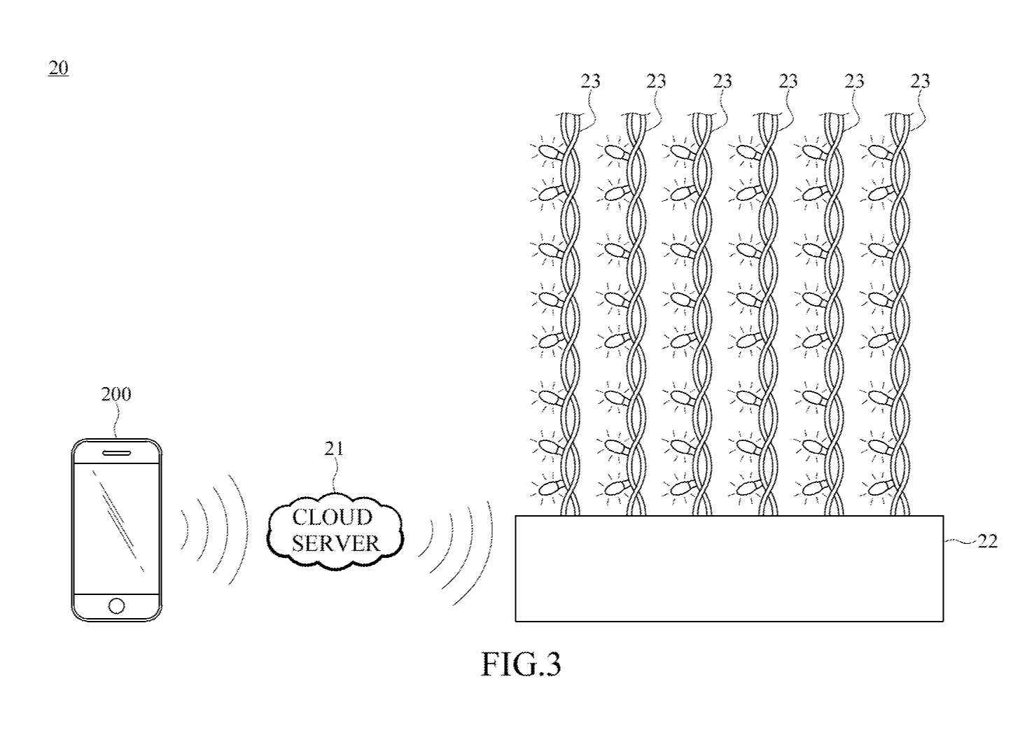

Referring to FIG. 2 and FIG. 3, FIG. 2 illustrates a block diagram of an editing device 200 for edit and preview of light control pattern and a light control system 20 to which the editing device 200 applied according to a second embodiment of the instant disclosure, and FIG. 3 illustrates a system level diagram according to the second embodiment of the instant disclosure. The editing device 200 of FIG. 2 is similar to the editing device 100 of FIG. 1; therefore, the analogous elements and their relationship and function are described above and have no need to give unnecessary details. In the embodiment, the light control system 20 comprises a cloud sever 21, a light control device 22, six lighting devices 23 (as shown in FIG. 3, but it is understood that the number of the lighting devices 23 is not limited to six), and the editing device 200. The editing device 200 is signally connected to the cloud server 21 via wireless communication protocol. The cloud server 21 is signally connected to the light control device 22 via wireless communication protocol. In another embodiment, the aforementioned signally connections can be via wires. The lighting devices 23 are, but are not limited to, connected to the light control device 22 via wires. Users can use the editing device 200 to record, create, edit and preview at least a light control pattern. Moreover, users can edit the light control pattern in accordance with at least a media file. The media file is, but is not limited to, an audio file such as mp3 file. The light control pattern is in accordance with sounds of the media file (e.g., sounds of the music of the mp3 file). When users finish the edition of the light control pattern, users can then upload light control patterns and/or corresponding media files to the cloud server 21 from the editing device 200. The cloud server 21 can transmit the light control patterns and/or media files to the light control device 22. The light control device 22 can generate light control commands in accordance with the light control pattern to control the lighting devices 23 to have LEDs thereon turned on/off or faded up/out. In the mean time, the light control device 22 can have a corresponding one of the music of the media files played by players and speakers simultaneously. As a result, the combination of music playing and light controlling has a visualized effect of the music.

The editing device 200 comprises an editing module 201, a screen 202, a memory 203, and a wireless communication module 205. The screen 202, the memory 203, and the wireless communication module 205 are, but are not limited to, electrically respectively connected to the editing module 201. The screen 202 is a touch screen. The memory 203 can be utilized for storing light control patterns and media files. The wireless communication module 205 can be utilized for being signally connected to the cloud server 21. The editing module 201 comprises an editing interface 210. The editing interface 210 comprises an input block 211, an effect block 212, a channel block 213, a media-playing block 214, a save block 215, and a preview block 216. The preview block 216 comprises a simulated lighting device editor 2161.

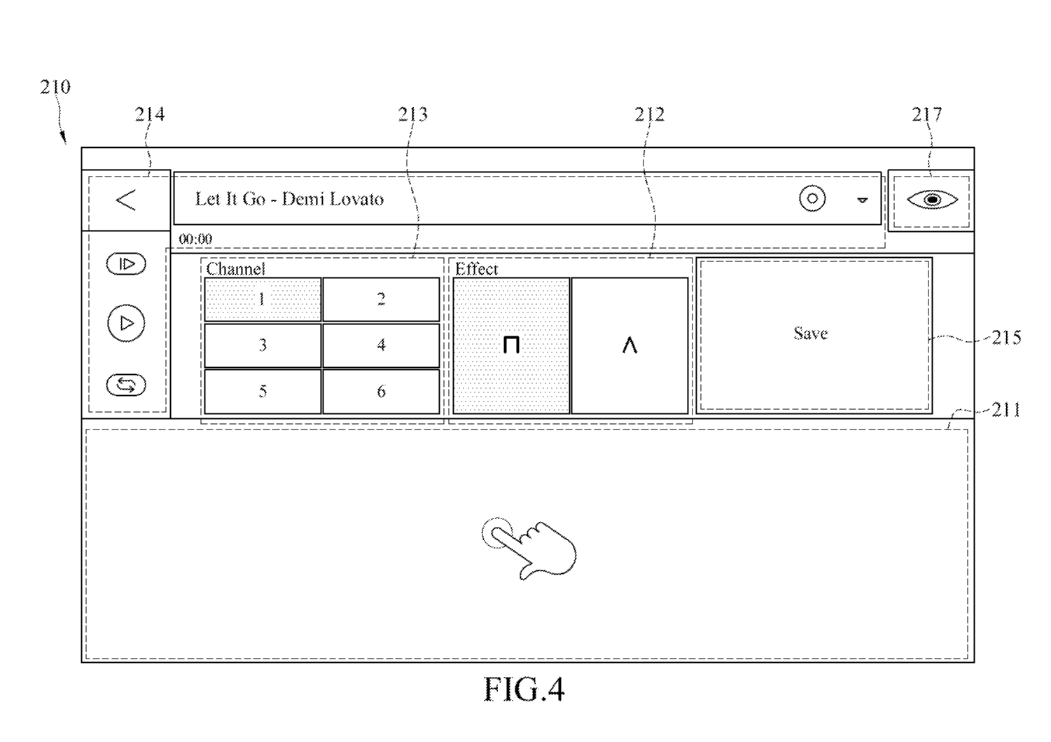

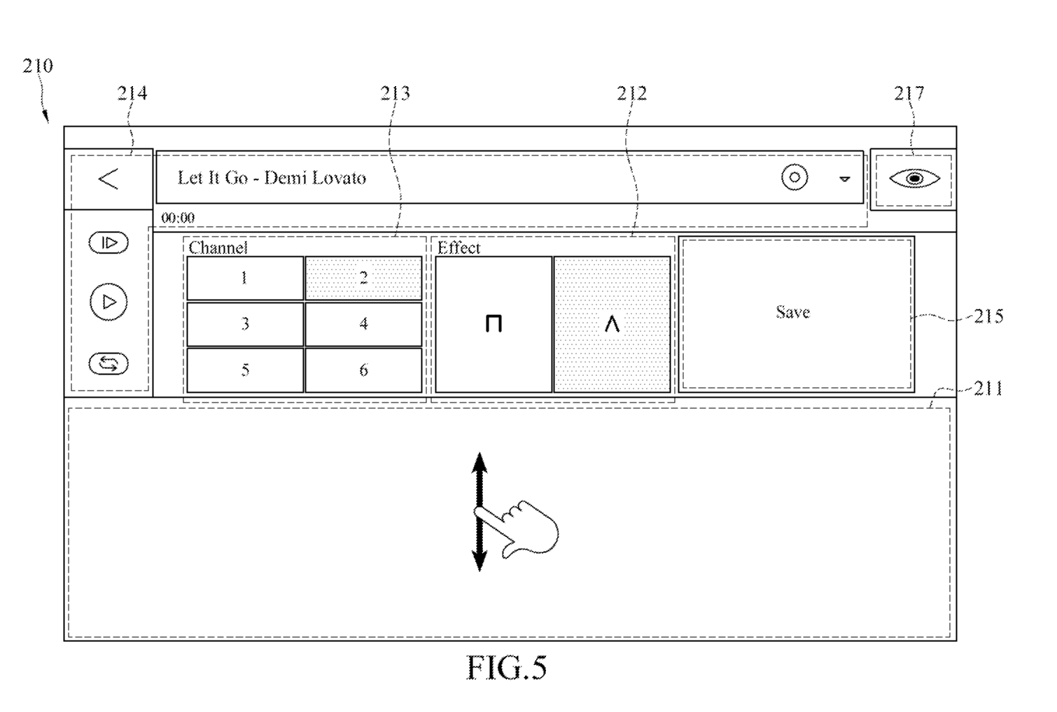

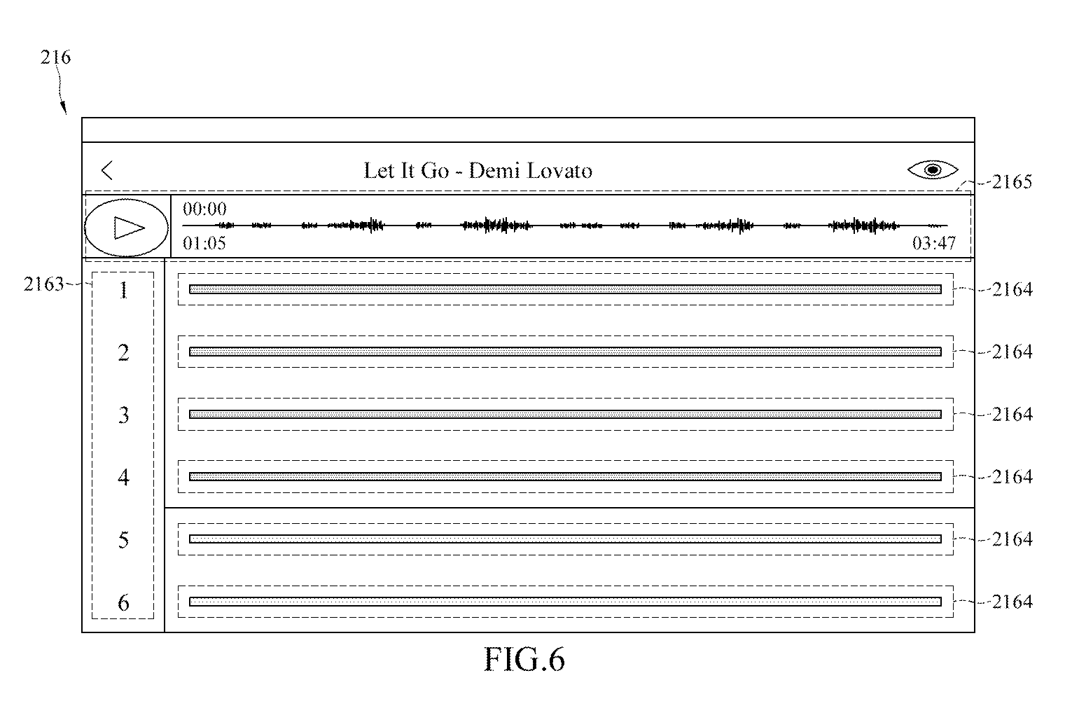

Referring to FIG. 2, FIG. 4, and FIG. 5, FIG. 4 illustrates the editing interface 210 with a point-touch operation of the editing device 200 according to the second embodiment of the instant disclosure, and FIG. 5 illustrates the editing interface 210 with a gesture-touch operation of the editing device 200 according to the second embodiment of the instant disclosure. The editing interface 210 is shown, when activated, on the screen 202. In the embodiment, each of the blocks including the input block 211, the effect block 212, the channel block 213, the media-playing block 214, the save block 215, and the preview block 216 respectively comprises a corresponding program coding and a corresponding interface image. These corresponding interface images are respectively shown on a corresponding area of the screen 202, as shown in FIG. 4 and FIG. 5 (the preview block 216 is shown in FIG. 6 and is described below). Users can touch an area of the screen 202 related to the input block 211 to activate the input block 211. When the input block 211 is activated, the editing module 201 records the time of the activation of the input block in a light control pattern. For example, If a user records and edits a light control pattern from 00:00 to 00:50, and the user touch the input block 211 of the screen 202 at 00:32 during the recording, the editing module 201 records the time (i.e., 00:32) in the light control pattern and applied an effect (e.g., a corresponding command) to a corresponding position related to the time in the light control pattern. What kind of effect can be applied depends on the selection of the user by touching the effect block 212. In the embodiment, the effect block 212 comprises a first effect selection and a second effect selection, as shown in FIG. 4 and FIG. 5. The first selection is marked by a symbol of square wave, and the second selection is marked by a symbol of triangular wave. The first effect selection is related to a light turning on and/or off effect of controlling the lighting device 23, and the second effect selection is related to a light fading up and/or out effect of controlling the lighting device 23. In another embodiment, the editing interface may have no effect block, and the effect related to light control patterns for controlling the lighting device is default (e.g., light turning on and off effect).

As shown in FIG. 4, if the first effect selection is selected, user can touch the input block 211 in a manner of point-touch (i.e., knocking or pressing on a point of the screen 202 of the input block 211) to activate the input block 211. Namely, the input block 211 is activated when the first effect selection is selected and an area of the touch screen 202 related to the input block 211 senses a point-touch signal. When pressing on a point of the input block 211, the effect recorded and related to the time of the activation in the light control pattern is to turn on the lighting device 23. When not pressing on the input block 211, the effect recorded and related to the time of the activation in the light control pattern is to turn off the lighting device 23. If a light control pattern is edited and recorded under the first selection of the effect block 212, the controlling of the lighting device 23 according to the light control pattern is similar to a square wave control.

As shown in FIG. 5, if the second effect selection is selected, user can touch the input block 211 in a manner of gesture-touch (i.e., pressing-and-sliding on the screen 202 of the input block 211) to activate the input block 211. Namely, the input block 211 is activated when the second effect selection is selected and the area of the touch screen 202 related to the input block 211 senses a gesture-touch signal. When pressing and upwardly sliding on the input block 211, the effect recorded and related to the time of the activation in the light control pattern is to have the lighting device 23 turned on and faded up (i.e., gradually increasing brightness). When downwardly sliding on the input block 211, the effect recorded and related to the time of the activation in the light control pattern is to have the lighting device 23 faded out (i.e., gradually decreasing brightness). If a light control pattern is edited and recorded under the second selection of the effect block 212, the controlling of the lighting device 23 according to the light control pattern is similar to a triangular wave control.

In the embodiment, the channel block 213 comprises six channels, as shown in FIG. 4 and FIG. 5. Each channel can be related to a corresponding light control pattern. Each light control pattern can be utilized for controlling a corresponding one of the lighting devices 23. Users can touch, for example, the channel 1 of the channel block 213 to edit and record a corresponding light control pattern related to the channel 1. And users can touch the channel 2 of the channel block 213 to edit and record another corresponding light control pattern related to the channel 2. When a channel of the channel block 213 is activated, the editing module 201 makes a sign on the activated channel (e.g., highlighting the activated channel of the channel block 213 shown on the screen 202) and relates a light control pattern the user is going to edit to the activated channel.

In the embodiment, the media-playing block 214 can be, when activated, utilized for playing at least a media file. The editing module 201 can record the time of the activation of the input block 211 in accordance with the playing of the media file in the light control pattern when the input block is activated. After finishing the edition and record of the light control pattern, users can touch the save block 215 to have the save block 215 activated so that the editing module 201 will save the recorded light control pattern and store it in the memory 203. In another embodiment, the light control pattern is automatically continuously saved in the memory during the process of edition. In the embodiment, when once the save block 215 is activated, the editing device 200 automatically transmits the light control pattern and the media file to the cloud server 21, and the light control device 22 accordingly receives the light control pattern and the media file from the cloud server 21. In another embodiment, the editing device may not transmit the media file to the cloud server automatically when the save block is activated.

For example, a user wants to edit and record six light control patters in accordance to a song “Let it go” with a length 03:47 and to have the light control device 22 control the six lighting devices 23 in accordance with the song when the speaker 450 is playing “let it go”. The user can select the channel 1 (or any other channel) of the channel block 213. Then the user selects an effect of the effect block 212. Next the user can start to have the song played by activating the media-playing block 214 and to edit a light control pattern related to the corresponding channel by activating the input block 211. During the recording of the light control pattern and the playing of the song, the user touch the screen 202 related to the input block 211 to edit the light control pattern by point-touch operations or gesture-touch operations according to the selection of the effect block 212. If the user touch the input block 211 at 00:32 during the recording and the playing, the editing module 201 records the time (i.e., 00:32) in the light control pattern and applied an effect (e.g., a corresponding command) to a corresponding position related to the time in the light control pattern. After the end of the playing of the song, the edition of the light control pattern related to the channel 1 is finish. Then the user can select the channels 2 to 6 one by one until the rest of five light control patterns respectively related to the channels 2 to 6 have edited and recorded. The user touches the save block 215, and the editing device 200 transmits the edited and recorded light control patterns and the song to the cloud server 21 via the wireless communication module 205. The light control device 22 accordingly receives the light control patterns and the song from the cloud server 21 via wireless communication protocol. During operation, the light control device 22 outputs six sets of light control commands for controlling the six lighting devices 23 in accordance with the playing of the song “let it go”.

Referring to FIG. 2, FIG. 4, FIG. 5, and FIG. 6, FIG. 6 illustrates the preview block 216 of the editing interface 210 of the editing device 200 according to the second embodiment of the instant disclosure. The editing interface 210 shown on the screen 202 (as shown in FIG. 4 and FIG. 5) further comprises a preview mode switching unit 217. Users can touch the preview mode switching unit 217 to have the editing interface 210 switched to the preview block 216. When the preview mode switching unit 217 is activated by touching, the preview block 216 is shown on the screen 202, as shown in FIG. 6. The preview block 216 comprises a channel list 2163, six diagrammatic marks 2164, and a media-playing block 2165 shown on the screen 202. The channel list 2163 lists numerals 1 to 6. The numerals 1 to 6 are respectively representative of the channels 1 to 6. In another embodiment, the channel list may list mere numeral 1 if the number of the channel is one; accordingly, the channel list may list numerals 1 and 2 if the number of the channel is two. In the embodiment, the six diagrammatic marks 2164 are automatically generated by the editing module 201 when the preview block 216 and the simulated lighting device editor 2161 are activated. In the embodiment, the simulated lighting device editor 2161 is automatically activated when the preview block 216 is activated. Namely, when users touch the preview mode switching unit 217 and the preview block 216 is activated, the simulated lighting device editor 2161 (i.e., a corresponding program coding running an operation in the background) is automatically activated and the editing module 201 automatically draw (i.e., display) the six diagrammatic marks 2164 on the screen 202. The number of the automatically generated diagrammatic marks 2164 is corresponding to that of the channels. Each of diagrammatic marks 2164 is positioned at the right of corresponding one of numerals 1 to 6 of the channel lists 2163 (i.e., the first diagrammatic mark 2164 at the right of the numeral 1 of the channel list 2163 is corresponding to the light control pattern of the channel 1).

The media-playing block 2165 can be utilized for playing media files. In the embodiment, when the media-playing block 2165 starts to play a media file, each of the diagrammatic marks 2164 selectively brightens in accordance with corresponding one of the light control patterns. For example, the light control patterns of channels 1 to 4 corresponding to the song “let it go” respectively records a light turning on effect at 01:05, and the light control patterns of channels 5 and 6 corresponding to the song “let it go” respectively records a light turning off effect at 01:05. When the song “let it go” is played by the media-playing block 2165 and the playing of the song comes to 01:05, the first four diagrammatic marks 2164 corresponding to the channels 1 to 4 brighten in accordance of the light control patterns of channels 1 to 4, and the last two diagrammatic marks 2164 corresponding to the channels 5 and 6 darken in accordance of the light control patterns of channels 5 and 6. In another embodiment, if a light control pattern of a channel records a light fading up/out effect at a certain time of the music of a media file, the corresponding diagrammatic mark starts to gradually increase/decrease brightness when the playing of the music comes to the certain time. In another embodiment, if an edited and recorded light control pattern is not in accordance with a media file, and the preview block has no media-playing block, the preview block may have a start unit (e.g., a diagrammatic button) shown on an area of the touch screen, which is capable of being touched by users for activating simulation process of the light control pattern regarding effect of light controlling.

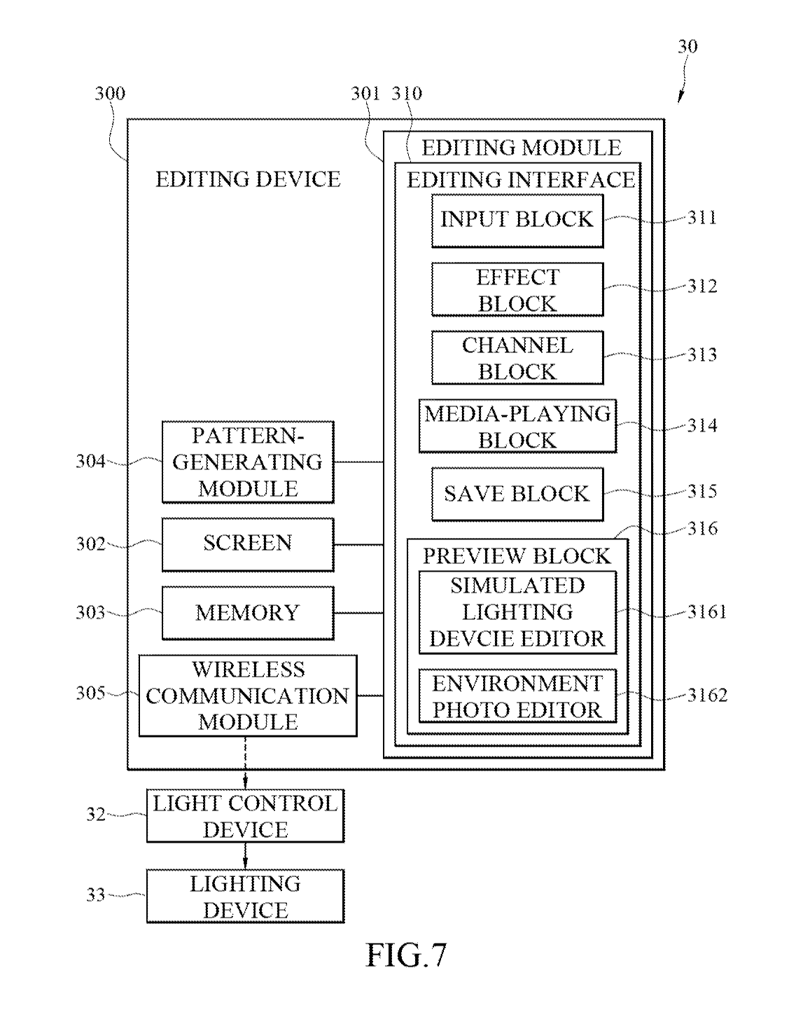

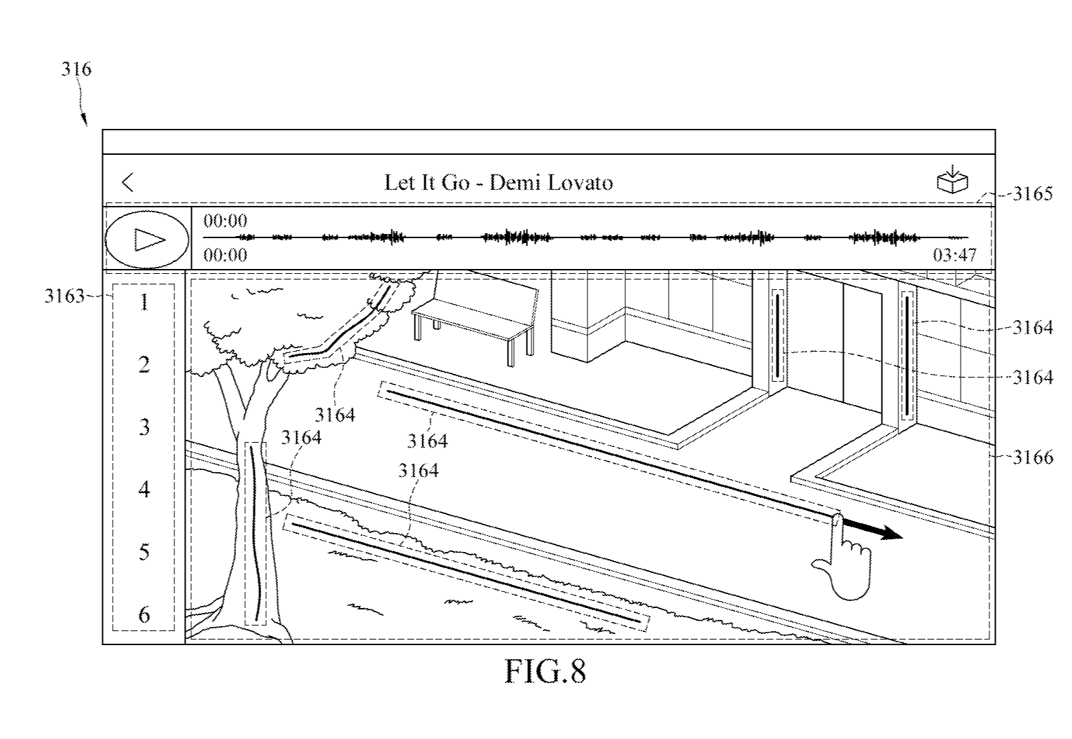

Referring to FIG. 7 and FIG. 8, FIG. 7 illustrates a block diagram of an editing device 300 for edit and preview of light control pattern and a light control system 30 to which the editing device 300 applied according to a third embodiment of the instant disclosure, and FIG. 8 illustrates a preview block 316 of an editing interface 310 of the editing device 300 according to the third embodiment of the instant disclosure. The editing device 300 of FIG. 7 is similar to the editing device 200 of FIG. 2; therefore, the analogous elements and their relationship and function are described above and have no need to give unnecessary details. In the embodiment, the light control system 30 comprises a light control device 32, a lighting device 33, and the editing device 300. The editing device 300 is signally connected to the light control device 32 via wireless communication protocol. The lighting device 33 is connected to the light control device 32 via a wire. Users can use the editing device 300 to record, create, edit and preview at least a light control pattern in accordance with at least a media file. When users finish the edition of the light control pattern, users can then have light control patterns and/or corresponding media files transmitted to the light control device 32 from the editing device 300. The light control device 32 can generate light control commands in accordance with the light control pattern to control the lighting device 33 to have LEDs thereon turned on/off or faded up/out along with the playing of the media files.

The editing device 300 comprises an editing module 301, a screen 302, a memory 303, a pattern-generating module 304, and a wireless communication module 305. The screen 302, the memory 303, the pattern-generating module 304, and the wireless communication module 305 are, but are not limited to, electrically respectively connected to the editing module 301. The screen 302 is a touch screen. The memory 303 can be utilized for storing light control patterns and media files. The pattern-generating module 304 is capable of automatically generating a generated light control pattern in accordance with characteristics of sounds of the media file. The characteristics may include rhythms, beats, accents, and classification of the music of the mp3 file. The pattern-generating module 304 may include an algorithm program which can recognize and analyze the characteristics, and automatically generate corresponding effects in accordance with the time of rhythms, beats, and accents of the music of the mp3 file. The wireless communication module 305 can be utilized for being signally connected to the light control device 32.

The editing module 301 comprises an editing interface 310. The editing interface 310 comprises an input block 311, an effect block 312, a channel block 313, a media-playing block 314, a save block 315, and a preview block 316. The input block 311, the effect block 312, the channel block 313, the media-playing block 314, and the save block 315 of the editing interface 310 are the same as the editing interface 210 as shown in FIG. 4 and FIG. 5.

When the editing interface 310 is switched to the preview block 316, the preview block 316 is shown on the screen 302, as shown in FIG. 8. The preview block 316 comprises a simulated lighting device editor 3161 and an environment photo editor 3162. The simulated lighting device editor 3161 and the environment photo editor 3162 are both program coding running operations in the background. When the simulated lighting device editor 3161 is activated, the editing module 301 draws at least a diagrammatic mark 3164 displayed on the screen 302. When the environment photo editor 3162 is activated, the editing module 301 displays an environment photo 3166 on the screen 302, and the diagrammatic marks 3164 are overlapped on the environment photo 3166. The simulated lighting device editor 3161 is activated when an area of the screen 302 related to the environment photo 3166 senses a point-touch signal or a gesture-touch signal.

As shown in FIG. 8, a user selects the environment photo 3166 by the environment photo editor 3162. For example, a browser (not shown) provided by the environment photo editor 3162 can be activated on the preview block 316 by the user, such that the user can select a photo as the environment photo 3166 from varied photos stored in the memory 303 via the browser. The environment photo 3166 may be with respect to an environment or a place, such as a yard, in which the user wants to have some decorations of one or more lighting devices 33. The environment photo editor 3162 is activated by the selection of the environment photo 3166 of the user; consequently, the environment photo 3166 is displayed on an area of the preview block 316 by the editing module 301.

The preview block 316 further comprises a channel list 3163 and a media-playing block 3165 shown on the screen 302. The channel list 3163 lists numerals 1 to 6. The numerals 1 to 6 are respectively representative of the channels 1 to 6. The media-playing block 3165 can be utilized for playing media files and activating the simulation of light control patterns corresponding to media files.

After the environment photo 3166 is displayed on the screen 302, the user can draw at least a diagrammatic mark 3164 manually. One or more diagrammatic marks 3164 that the user draws are overlapped on the environment photo 3166. Each of the diagrammatic marks 3164 is related to corresponding one of the channels of the channel block 313. Each of the channels is related to corresponding one of the light control patterns. As a result, the number of the diagrammatic marks 3164 is corresponding to that of the channels. There are six channels and six corresponding light control patterns needed to be simulated in the embodiment, the users can sequentially draw six diagrammatic marks 3164, and the six diagrammatic marks 3164 are respectively representative of the six channels in sequence. For example, the user draws a first diagrammatic mark 3164 and then draws a second diagrammatic mark 3164. The first diagrammatic mark 3164 is representative of the channel 1, and the second diagrammatic mark 3164 is representative of the channel 2.

In another embodiment, the channel list is selectable. For example, the user can select the numeral 3 of the channel list and then draw a diagrammatic mark; accordingly, the diagrammatic mark is representative of the channel 3. Specifically, once a diagrammatic mark the user draws after selecting a numeral of the channel list (i.e., activating a channel), the editing module accordingly relates the diagrammatic mark to the selected numeral of the channel list and, consequently, to the corresponding channel.

In some embodiments, the diagrammatic mark 3164 can be a point, such as a solid circle, or a string depending on how the user draws and what kind of corresponding light device 33 the user wants to decorate is. For example, if the user wants to have the path of the yard (shown by the environment photo 3166 of FIG. 8) decorated with a light device 33, which is a light string with LEDs thereon, the user can draw a diagrammatic mark 3164, which is a diagrammatic string, on a corresponding position of the environment photo 3166 in a manner of gesture-touch (i.e., pressing-and-sliding on the screen 302, as shown in FIG. 8). In another embodiment, if the user wants to have the path of the yard decorated with a light device pertaining to a single point light source, the user can draw a diagrammatic mark, which is a diagrammatic solid circle, on a corresponding position of the environment photo in a manner of point-touch (i.e., knocking or pressing on a point of the screen). When the media-playing block 3165 starts to play a media file, each of the diagrammatic marks 3164 selectively brightens and/or darkens in accordance with corresponding one of the light control patterns. In another embodiment, if a light control pattern of a channel records a light fading up/out effect at a certain time of the music of a media file, the corresponding diagrammatic mark (e.g., a diagrammatic circle or string) starts to gradually increase/decrease brightness when the playing of the music comes to the certain time. By the preview block 316, the user can preview the effect of simulated light control, which is a reference to the user about how to decorate the environment with the lighting devices 33 and what's the effect of the decoration looks like. In addition, the formation, such as position, shape, or length, of diagrammatic marks 3164 can be easily arranged; therefore, the user can conveniently preview the effect of simulated light control with respect to different arrangements of the lighting devices 33.

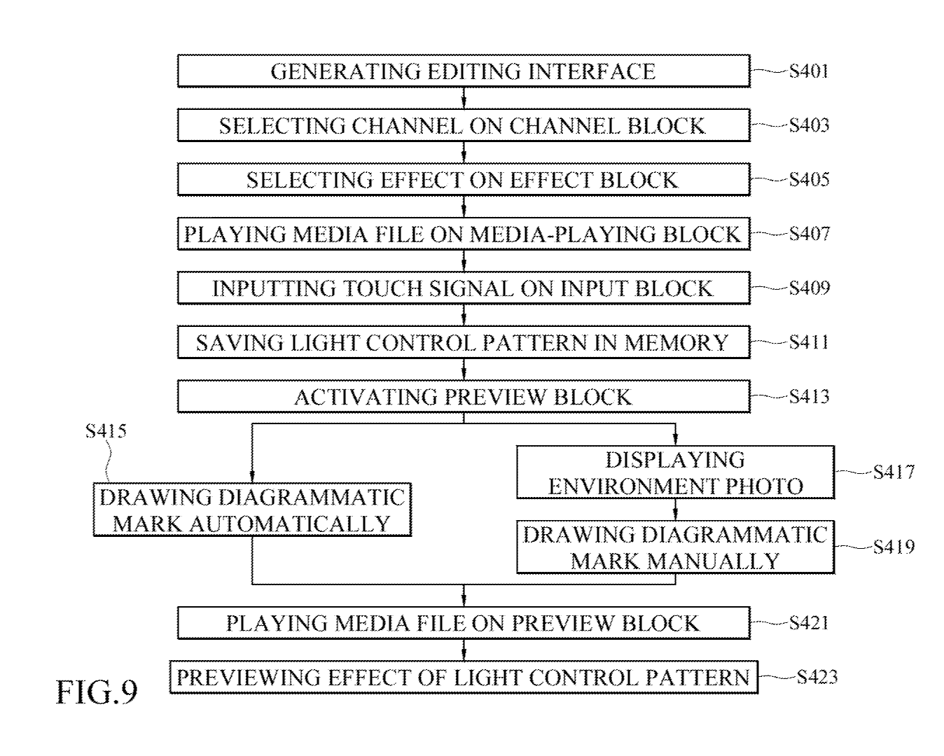

Referring to FIG. 9, FIG. 9 illustrates a flow chart of a method for edit and preview of light control pattern according to a fourth embodiment of the instant disclosure. The flow chart of FIG. 9 can be applied to one or more aforementioned editing devices. The flow chart of FIG. 9 is summarized from the above embodiments. Analogous elements and their relationship and function are described above and have no need to give unnecessary details. In the step S401, a user wanting to edit and record a light control pattern can activate an editing interface on an editing device by, for example, touching a corresponding icon shown on a touch screen of the editing device. After touching the corresponding icon, an editing module of the editing device generates the editing interface, and the editing interface is displayed on the touch screen. In the step S403, the user can select a channel of a channel block of the editing interface on the editing device. When a channel is selected (i.e., activated), the channel block has the activated channel marked by a sign (e.g., highlighting the activated channel) and has the light control pattern the user wants to edit related to the activated channel. In the step S405, the user can select an effect of an effect block of the editing interface. In the step S407, the user can activate a media-playing block of the editing interface to play a media file, and the edition of the light control pattern accordingly starts. In the step S409, the user can input touch signals on an input block of the editing interface by touching an area of the touch screen of the editing device so that the edit device records the time of the activation of the input block in the light control pattern in accordance with the playing of the media file. In the step S411, the user finishes the edition of the light control pattern. The user can touch a save block of the editing interface to save the light control pattern in the memory. In the step S413, the user can activate a preview block of the editing interface. The editing interface is switched to the preview block.

The preview block may have two modes. One mode of the preview block can be referred to FIG. 6 and the second embodiment. The other mode of the preview block can be referred to FIG. 8 and the third embodiment. The editing interface may comprise one of the two modes of the preview block. Alternatively, the editing interface may comprise both of the two modes of the preview block, and the two modes can be switched to one other by, for example, a mode-switching unit (i.e., a corresponding icon of the editing interface shown on the touch screen).

When the preview block is activated, the step S415 is performed if the mode of the preview block pertains to the second embodiment. Alternatively, the steps S417 and S419 are performed if the mode of the preview block pertains to the third embodiment. In the step S415, a simulated lighting device editor of the preview block draws (i.e., displays) one or more diagrammatic marks automatically when the simulated lighting device editor is activated. In the embodiment, the simulated lighting device editor is activated along with the activation of the preview block. Each of the diagrammatic marks is related to a corresponding one of the channels. In the step S417, an environment photo editor of the preview block displays an environment photo on the touch screen when the environment photo editor is activated. In the embodiment, the environment photo editor is activated when the user selects the environment photo by a browser of the preview block. In the step S419, the simulated lighting device editor draws one or more diagrammatic marks when the simulated lighting device editor is activated. In the embodiment, the simulated lighting device editor is activated when an area of the touch screen related to the environment photo senses a point-touch signal or a gesture-touch signal. In other words, the user can touch an area of the touch screen related to the environment photo in a manner of point-touch or gesture-touch to draw the diagrammatic marks manually.

After at least a diagrammatic mark is drawn, the user may want to preview the effect of simulated light control with regard to the light control pattern on the editing device. In the step S421, the media file is played by a media-playing block of the preview block. In the step S423, the at least a diagrammatic mark selectively brightens and/or darkens in accordance with the corresponding light control pattern along with the playing of the media file; therefore, the user can preview the effect of the light control pattern by the simulation of the preview block.

It shall be understood that a sequence for executing the described steps can be various according to different situation. And ordinal numbers such as “first”, “second”, and “third” used before elements or values are not intended to imply priorities or sequences. These ordinal numbers are merely utilized for clarifying different elements or values with the same name.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. An editing device for edit and preview of light control pattern, comprising:
an editing module comprising an editing interface, the editing interface comprising an input block and a preview block comprising a simulated lighting device editor; and
a screen displaying the editing interface;
wherein when the input block is activated, the editing module records the time of the activation of the input block in at least a light control pattern for light control;
wherein when the simulated lighting device editor is activated, the editing module draws at least a diagrammatic mark displayed on the screen; and
wherein when the preview block is activated, the diagrammatic mark is capable of selectively brightening in accordance with the light control pattern.

2. The editing device for edit and preview of light control pattern of claim 1, wherein the preview block further comprises an environment photo editor, and when the environment photo editor is activated, the editing module displays an environment photo on the screen, and the diagrammatic mark is overlapped on the environment photo.

3. The editing device for edit and preview of light control pattern of claim 2, wherein the screen is a touch screen, and the simulated lighting device editor is activated when an area of the touch screen related to the environment photo senses a point-touch signal or a gesture-touch signal.

4. The editing device for edit and preview of light control pattern of claim 1, wherein each of the diagrammatic marks selectively brightens in accordance with corresponding one of the light control patterns.

5. The editing device for edit and preview of light control pattern of claim 1, further comprising a wireless communication module receiving the light control pattern, wherein the wireless communication module transmits the light control pattern to at least a light control device or to a cloud server signally connected to the light control device via wireless communication protocol.

6. The editing device for edit and preview of light control pattern of claim 1, wherein the editing interface further comprises a channel block, and when a channel of the channel block is activated, the editing module makes a sign on the activated channel and relates the light control pattern to the activated channel.

7. The editing device for edit and preview of light control pattern of claim 1, further comprising a memory, wherein the editing interface further comprises a save block, and when the save block is activated, the editing module saves the recorded light control pattern in the memory.

8. The editing device for edit and preview of light control pattern of claim 1, wherein the editing interface further comprises an effect block, and when an effect of the effect block is activate, the editing module has the activated effect correspond to the time of the activation of the input block in the light control pattern.

9. The editing device for edit and preview of light control pattern of claim 8, wherein the effect block comprises a first effect selection and a second effect selection, the first effect selection is related to a light turning on or off effect of controlling a lighting device, and the second effect selection is related to a light fading up or out effect of controlling the lighting device.

10. The editing device for edit and preview of light control pattern of claim 1, wherein the screen is a touch screen, and the input block is activated when an area of the touch screen related to the input block senses a point-touch signal or a gesture-touch signal.

11. The editing device for edit and preview of light control pattern of claim 1, wherein the editing interface further comprises a media-playing block playing at least a media file, the editing module records the time of the activation of the input block in accordance with the playing of the media file in the light control pattern when the input block is activated, and the diagrammatic mark selectively brightens in accordance with the light control pattern and the playing of the media file when the preview block is activated.

12. The editing device for edit and preview of light control pattern of claim 11, further comprising a pattern-generating module, and the pattern-generating module is capable of automatically generating a generated light control pattern in accordance with characteristics of sounds of the media file.

13. The editing device for edit and preview of light control pattern of claim 1, wherein the editing device is a smart phone, a tablet computer, or a laptop computer.

14. A method for edit and preview of light control pattern comprising:
generating an editing interface on an editing device, wherein the editing interface comprises:
an input block having, when activated, the time of the activation of the input block recorded in at least a light control pattern for light control;
a save block saving, when activated, the light control pattern; and
a preview block comprising a simulated lighting device editor; and
drawing at least a diagrammatic mark displayed on a screen of the editing device when the simulated lighting device editor is activated;
wherein when the preview block is activated, the diagrammatic mark is capable of selectively brightening in accordance with the light control pattern.

15. The method for edit and preview of light control pattern of claim 14, wherein the preview block further comprises:
an environment photo editor displaying, when activated, an environment photo on the screen;
wherein the diagrammatic mark is overlapped on the environment photo.

16. The method for edit and preview of light control pattern of claim 15, wherein the screen is a touch screen, and the drawing the diagrammatic mark further comprises drawing the diagrammatic mark when an area of the touch screen related to the environment photo senses a point-touch signal or a gesture-touch signal.

17. The method for edit and preview of light control pattern of claim 15, wherein the editing interface further comprises:
a media-playing block playing, when activated, at least a media file, wherein the record of the time of activation of the input block is in accordance with the playing of the media file, the light control pattern is in accordance with sounds of the media file, and the diagrammatic mark selectively brightens in accordance with the light control pattern and the playing of the media file when the preview block is activated;
a channel block having, when activated, an activated channel marked by a sign and the light control pattern related to the activated channel; and
an effect block having, when activated, an activated effect correspond to the time of the activation of the input block in the light control pattern.

18. The method for edit and preview of light control pattern of claim 17, further comprising relating the diagrammatic mark to a corresponding channel.

19. The method for edit and preview of light control pattern of claim 18, wherein the drawing the diagrammatic mark further comprises sequentially drawing a plurality of diagrammatic marks overlapped on the environment photo, wherein each of the diagrammatic marks is related to corresponding one of the channels of the channel block, and each of the channels is related to corresponding one of the light control patterns.

20. The method for edit and preview of light control pattern of claim 19, wherein each of the diagrammatic marks selectively brightens in accordance with corresponding one of the light control patterns.
